(19) United States
(12) Patent Application Publication
(10) Pub. No.: US 2025/0171040 A1
(43) Pub. Date: May 29, 2025

(54) VEHICLE CONTROL DEVICE, STORAGE MEDIUM STORING COMPUTER PROGRAM FOR VEHICLE CONTROL, AND METHOD FOR CONTROLLING VEHICLE

(71) Applicant: TOYOTA JIDOSHA KABUSHIKI KAISHA, Toyota-shi Aichi-ken (JP)

(72) Inventors: Yusuke Mori, Koto-ku Tokyo-to (JP); Kenta Kumazaki, Bunkyo-ku Tokyo-to (JP); Tomohiro Hara, Odawara-shi Kanagawa-ken (JP)

(73) Assignee: TOYOTA JIDOSHA KABUSHIKI KAISHA, Toyota-shi Aichi-ken (JP)

(21) Appl. No.: 18/952,494

(22) Filed: Nov. 19, 2024

(30) Foreign Application Priority Data
Nov. 28, 2023 (JP) 2023-200746

(51) Int. Cl. B60W 50/06; B60W 50/00; H04L 67/125

(52) U.S. Cl. CPC B60W 50/06; H04L 67/125; B60W 2050/0005; B60W 2050/065; B60W 2520/10

(57) ABSTRACT

A vehicle control device has a first processing device that generates an output signal using only a machine learning-trained classifier, a second processing device that has lower power consumption than the first processing device and generates an output signal without using a machine learning-trained classifier, and a processor configured to decide a processing ratio between a portion processed by the first processing device and a portion processed by the second processing device, based on at least one information from among vehicle information representing a state of a vehicle, environment information representing surrounding environment of the vehicle, and terrain information representing a terrain including a current location of the vehicle.

### CROSS-REFERENCE TO RELATED APPLICATIONS

This application claims priority to Japanese Patent Application No. 2023-200746 filed Nov. 28, 2023, the entire contents of which are herein incorporated by reference.

### FIELD

The present disclosure relates to a vehicle control device, a storage medium storing a computer program for controlling a vehicle, and a method for controlling a vehicle.

### BACKGROUND

An increasing number of the processes carried out in vehicles are being controlled by automatic control devices. The automatic control devices that control the vehicles therefore consume increasing levels of electric power. Among automatic control devices, there are control devices that generate output signals

using only a machine learning-trained classifier (AI-only model), control devices having a control unis that generate output signals using only a machine learning-trained classifier and a control unit that generates output signals without using a machine learning-trained classifier (hybrid model), and control devices that generate output signals without using a machine learning-trained classifier (rule-based model). Power consumption is highest with the AI-only model and lowest with the rule-based model, while the hybrid model has a level of power consumption between the two models.

Japanese Unexamined Patent Publication No. 2023-094745, for example, proposes reducing the computation load (power consumption) of an ECU by appropriately switching to an AI model suited for the current traveling scene or traveling location.

### SUMMARY

While it is important to reduce vehicle power consumption, there is also a need to ensure vehicle safety. Vehicle safety is highest with the AI-only model and lowest with the rule-based model, while the hybrid model has a level of safety between the two models. The order of vehicle safety is therefore different from the order of power consumption.

It is desirable to control a vehicle depending on the vehicle conditions so as to ensure safety while reducing power consumption.

It is therefore an object of the present disclosure to provide a vehicle control device that controls a vehicle depending on the vehicle conditions, so as to ensure safety while reducing power consumption.

(1) One embodiment of the present disclosure provides a vehicle control device. The vehicle control device has a first processing device that generates an output signal using only a machine learning-trained classifier, a second processing device that has lower power consumption than the first processing device and generates an output signal without using a machine learning-trained classifier, and a processor configured to decide a processing ratio between a portion processed by the first processing device and a portion processed by the second processing device, based on at least one information from among vehicle information representing a state of a vehicle, environment information representing surrounding environment of the vehicle, and terrain information representing terrain including a current location of the vehicle.

(2) In the vehicle control device of embodiment (1), the vehicle control device further has a plurality of the first processing devices, a plurality of the second processing devices, a first control device that has one of the first processing devices and one of the second processing devices, a second control device that has higher power consumption than the first control device and generates an output signal using only another of the first processing devices; and a third control device that has lower power consumption than the first control device and generates an output signal using only another of the second processing devices, and the processor is further configured to select a selected control device for control of the vehicle from among the first control device, second control device and third control device based on the decided processing ratio.

(3) The vehicle control device of embodiment (1) or (2), the vehicle information includes degree of operation of the vehicle, and the processor is further configured to decide the processing ratio according to the degree of operation of the vehicle.

(4) The vehicle control device of embodiment (3), the vehicle information includes speed of the vehicle, and the processor is further configured to decide the processing ratio so that the portion processed by the first processing device is greater than the portion processed by the second processing device when the speed of the vehicle is slow compared to when the speed of the vehicle is fast.

(5) The vehicle control device of any one of embodiments (1) to (4), the environment information includes complexity of the surrounding environment of the vehicle, and the processor is further configured to decide the processing ratio so that the portion processed by the first processing device is greater than the portion processed by the second processing device when the degree of complexity of the surrounding environment of the vehicle is high, compared to when the degree of complexity of the surrounding environment of the vehicle is low.

(6) The vehicle control device of any one of embodiments (1) to (5), the terrain information includes degree of complexity of the terrain including the current location of the vehicle, and the processor is further configured to decide the processing ratio so that the portion processed by the first processing device is greater than the portion processed by the second processing device when the degree of complexity of the terrain including the current location of the vehicle is high, compared to when the degree of complexity of the terrain including the current location of the vehicle is low.

(7) The vehicle control device of embodiment (2), the processor is further configured to decide amount of information to be input to the selected control device that has been selected, based on at least one information from among the vehicle information, environment information and terrain information.

(8) The vehicle control device of embodiment (7), the amount of information includes number of sensors with which detected information is input to the selected control.

(9) According to another embodiment a computer program for vehicle control is provided. The computer program for vehicle control causes a processor to execute a process, and the process includes deciding a processing ratio between a portion processed by a first processing device that generates an output signal using only a machine learning-trained classifier, and a portion processed by a second processing device that has lower power consumption than the first processing device and generates an output signal without using a machine learning-trained classifier, based on at least one information from among vehicle information representing a state of a vehicle, environment information representing surrounding environment of the vehicle, and terrain information representing a terrain including a current location of the vehicle.

(10) Another embodiment of the present disclosure provides a method for controlling a vehicle. The method for controlling a vehicle includes deciding a processing ratio between a portion processed by a first processing device that generates an output signal using only a machine learning-trained classifier, and a portion processed by a second processing device that has lower power consumption than the first processing device and generates an output signal without using a machine learning-trained classifier, based on at least one information from among vehicle information representing a state of a vehicle, environment information representing surrounding environment of the vehicle, and terrain information representing a terrain including a current location of the vehicle.

Since the vehicle control device of this disclosure decides on a processing ratio between the portion processed by the first processing device and a portion processed by the second processing device depending on the vehicle conditions, the vehicle control device can control the vehicle in a manner ensuring safety while reducing power consumption.

The object and advantages of the present disclosure will be realized and attained by the elements and combinations particularly specified in the claims. It is to be understood that both the foregoing general description and the following detailed description are exemplary and explanatory and are not restrictive of the present disclosure, as claimed

### BRIEF DESCRIPTION OF DRAWINGS

FIG. 1 is a diagram illustrating operation of a decision device of the embodiment in overview.

FIG. 2 is a hardware configuration diagram for a vehicle in which the decision device of the embodiment is mounted.

FIG. 3 is a diagram illustrating a control device.

FIG. 4 is an example of an operation flow chart for vehicle control processing by a decision device.

FIG. 5A is a diagram illustrating decision on processing ratio based on vehicle information.

FIG. 5B is a diagram illustrating the relationship between vehicle information and power consumption.

FIG. 6A is a diagram illustrating decision on processing ratio based on environment information.

FIG. 6B is a diagram illustrating the relationship between environment information and power consumption.

FIG. 7A is another diagram illustrating decision on processing ratio based on environment information.

FIG. 7B is another diagram illustrating the relationship between environment information and power consumption.

FIG. 8A is a diagram illustrating decision on processing ratio based on terrain information.

FIG. 8B is a diagram illustrating the relationship between terrain information and power consumption.

FIG. 9 is an example of an operation flow chart for change processing by a decision device.

FIG. 10A is a diagram illustrating decision on information amount based on vehicle information.

FIG. 10B is a diagram illustrating decision on information amount based on environment information.

FIG. 11A is another diagram illustrating decision on information amount based on environment information.

FIG. 11B is a diagram illustrating decision on information amount based on terrain information.

FIG. 12A shows a diagram illustrating an example of operation of a switching unit.

FIG. 12B also shows another diagram illustrating an example of operation of a switching unit.

### DESCRIPTION OF EMBODIMENTS

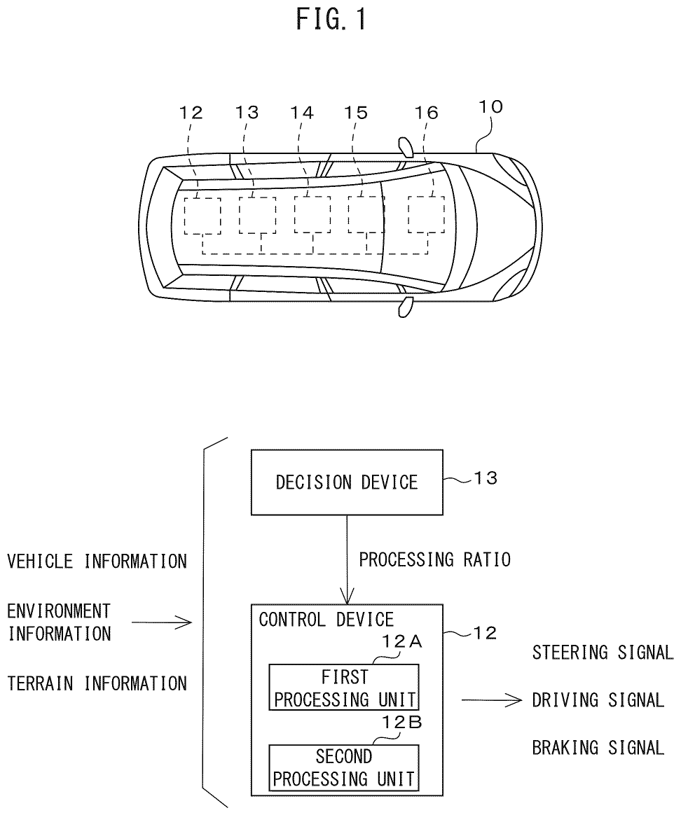

FIG. 1 is a diagram illustrating operation of a decision device 13 of the embodiment in overview. Operation of the decision device 13 of this embodiment will be explained in overview with reference to FIG. 1.

The vehicle 10 has a control device 12 and a decision device 13. The vehicle 10 may also be a self-driving vehicle. The control device 12 inputs vehicle information representing the state of the vehicle, environment information representing the surrounding environment of the vehicle, and terrain information representing the terrain including the current location of the vehicle, and outputs a steering signal that controls a steering device 14, a driving signal that controls a drive unit 15 such as an engine or motor, and a braking signal that controls a braking device 16. The control device 12 and decision device 13 are examples of vehicle control devices.

The control device 12 has a first processing unit 12A that generates output signals using only a machine learning-trained classifier, and a second processing unit 12B that generates output signals without using a machine learning-trained classifier. The second processing unit 12B is a “rule-based” control device that generates signals according to a predetermined algorithm. The first processing unit 12A, on the other hand, is an “AI-based” control device that essentially does not carry out rule-based control processing.

The first processing unit 12A can safely control the vehicle in response to various vehicle information, as well as complex environment information and terrain information. A relatively large amount of electric power is consumed for operation of the first processing unit 12A.

The second processing unit 12B has lower power consumption than the first processing unit 12A. Specifically, average power consumption by the second processing unit 12B is lower than the first processing unit 12A, but it is also inferior to the first processing unit 12A in terms of safety during control of the vehicle 10.

The control device 12 is able to vary the processing ratio between the portion processed by the first processing unit 12A and the portion processed by the second processing unit 12B.

The decision device 13 decides the processing ratio for the control device 12 based on one or more information types from among the vehicle information, environment information and terrain information. The speed of the vehicle 10 is one example of vehicle information.

For example, the deciding unit 13 decides on a processing ratio such that the portion processed by the first processing unit 12A is greater than the portion processed by the second processing unit 12B, for a slower speed of the vehicle 10 compared to a faster speed of the vehicle 10.

When the speed of the vehicle 10 is slow, the vehicle 10 may be traveling on a city road. City roads have more moving objects such as other vehicles and pedestrians. The vehicle 10 is also controlled in response to intersections and traffic lights on city roads. In some embodiments, when the speed of the vehicle 10 is slow, therefore, the control device 12 may be able to safely control the vehicle in response to complex environment or terrain.

When the speed of the vehicle 10 is fast, on the other hand, the vehicle 10 may be traveling on a motorway. There are no traffic lights or pedestrians on motorways. In addition, motorways tend to have straight roads and terrain with few branches or merges. When the speed of the vehicle 10 is fast, therefore, it is sufficient for the control device 12 to safely control the vehicle in response to relatively simple environment and terrain.

When the speed of the vehicle 10 is slow, therefore, the decision device 13 increases the processing ratio of processing by the first processing unit 12A in order to ensure safety. When the speed of the vehicle 10 is fast, on the other hand, the decision device 13 increases the processing ratio of processing by the second processing unit 12B in order to reduce power consumption.

Since the decision device 13 of the embodiment described above decides on a processing ratio between the portion processed by the first processing unit and a portion processed by the second processing unit, it can control the vehicle in a manner ensuring safety while reducing power consumption, in a manner depending on the vehicle conditions.

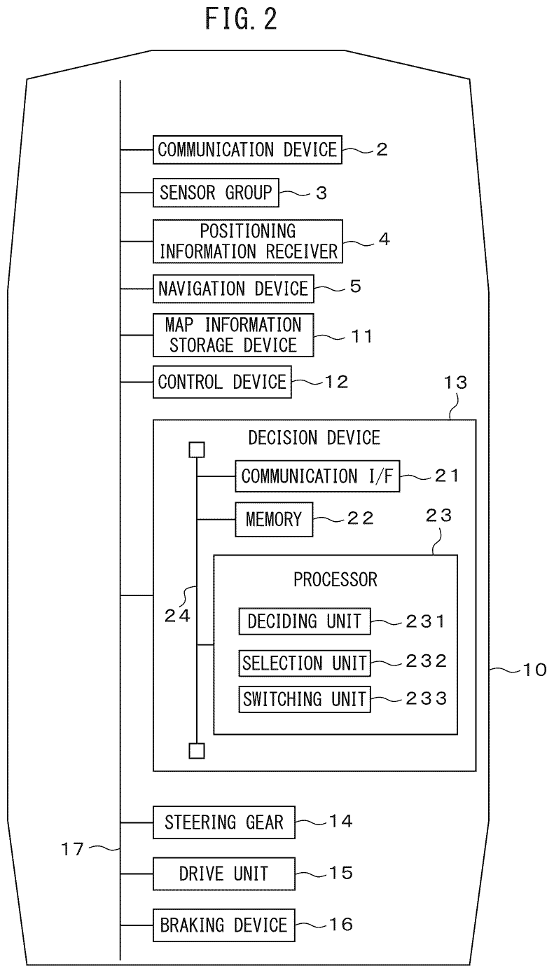

The vehicle 10 in which the decision device 13 is mounted will now be explained with reference to FIG. 2. FIG. 2 is a hardware configuration diagram for a vehicle in which the decision device 13 of the embodiment is mounted.

The vehicle 10 has a communication device 2, a sensor group 3, a positioning information receiver 4, a navigation device 5, a map information storage device 11, a control device 12, a decision device 13, a steering device 14, a drive unit 15 and a braking device 16.

The communication device 2, sensor group 3, positioning information receiver 4, navigation device 5, map information storage device 11, control device 12, decision device 13, steering gear 14, drive unit 15 and braking device 16 are connected in a communicable manner through an in-vehicle network 17 that conforms to controller area network standards.

The communication device 2 has an interface circuit for connection of the decision device 13 to a communication network (not shown) via a macrocell base station (not shown).

The sensor group 3 has a plurality of sensors for detection of vehicle information, environment information and terrain information. For example, the sensor group 3 has a speed sensor for detection of information representing the speed of the vehicle 10 and a fuel sensor for detection of information representing the amount of electric storage or remaining level of fuel, as sensors for detection of vehicle information.

The sensor group 3 also has a front camera, rear camera, LiDAR sensor, millimeter wave radar sensor and ultrasonic sensor, for example, as sensors for detection of environment information. The front camera acquires images representing the environment in a predetermined range ahead of the vehicle 10. The rear camera acquires images representing the environment in a predetermined range behind the vehicle 10. The LiDAR sensor acquires reflected wave information representing laser-reflecting objects surrounding the vehicle 10. The millimeter wave radar sensor acquires reflected wave information representing millimeter wave-reflecting objects surrounding the vehicle 10. The ultrasonic sensor acquires reflected wave information representing ultrasonic wave-reflecting objects surrounding the vehicle 10. The sensor group 3 may also have a rainfall sensor that detects information representing the amount of rainfall around the vehicle 10, as a sensor for detection of environment information.

The front camera, and the millimeter wave radar that detects the environment ahead of the vehicle 10, are examples of front sensors that detect environment information ahead of the vehicle 10. The rear camera, and the millimeter wave radar that detects the environment behind the vehicle 10, are examples of rear sensors that detect environment information behind the vehicle 10. The millimeter wave radar and LiDAR sensors that detect the environment to the sides of the vehicle 10, are examples of side sensors that detect environment information to the sides of the vehicle. The ultrasonic sensor is an example of an ambient sensor that detects environment information in the surrounding neighborhood of the vehicle.

The sensors for detection of environment information, such as the front camera and LiDAR sensors, are also used as sensors for acquiring terrain information representing the roads around the vehicle 10.

The sensor group 3 outputs the information detected by the sensors to the control device 12 and decision device 13 via the in-vehicle network 17.

The positioning information receiver 4 outputs positioning information that represents the current location of the vehicle 10. The positioning information receiver 4 may be a GNSS receiver, for example. The positioning information receiver 4 outputs positioning information and the positioning information acquisition time at which the positioning information has been acquired, to the navigation device 5 and map information storage device 11, each time positioning information is acquired at a predetermined receiving cycle.

Based on the navigation map information, the destination location of the vehicle 10, and positioning information representing the current location of the vehicle 10 input from the positioning information receiver 4, the navigation device 5 creates a navigation route from the current location to the destination location of the vehicle 10. When the destination location has been newly set or the current location of the vehicle 10 has exited the navigation route, the navigation device 5 creates a new navigation route for the vehicle 10. Every time a navigation route is created, the navigation device 5 outputs the navigation route to the control device 12, for example, via the in-vehicle network 17.

The map information storage device 11 stores wide-area map information for a relatively wide area (an area of 10 to 30 km², for example) that includes the current location of the vehicle 10. In some embodiments, the map information has high-precision map information including three-dimensional information for the road surface, the speed limit for the road, the curvature of the road, and information for the types and locations of structures and road features such as road lane marking lines. A single lane is represented in the map information as a series of a plurality of lane links.

The map information storage device 11 receives the wide-area map information from an external server (not shown) via a macrocell base station (not shown), by wireless communication through a communication device 2 mounted in the vehicle 10, in relation to the current location of the vehicle 10, and stores it in the storage device. Each time positioning information is input from the positioning information receiver 4, the map information storage device 11 refers to the stored wide-area map information and outputs map information for a relatively narrow area including the current location represented by the positioning information (for example, an area of 100 m² to 10 km²), through the in-vehicle network 17 to the control device 12 and decision device 13. The map information is an example of terrain information.

The control device 12 calculates the current location and orientation of the vehicle 10 based on the terrain information and environment information. The control device 12 acquires the state of the vehicle 10, such as its speed, based on the vehicle information. The control device 12 detects objects surrounding the vehicle 10 based on the environment information. Such objects include moving objects such as other vehicles and pedestrians, as well as stationary objects such as guard rails. The control device 12 also detects road features such as lane marking lines, signs and traffic lights, based on the environment information. The control device 12 acquires information representing roads around the vehicle 10 based on the terrain information.

The control device 12 generates a traveling lane plan representing the scheduled traveling lane in which the vehicle 10 is to travel, based on current location of the vehicle 10, the navigation route, and the vehicle information, environment information and terrain information. The control device 12 also generates a driving plan representing a scheduled traveling trajectory for the vehicle 10 until a predetermined time (such as 5 seconds), based on the traveling lane plan.

The control device 12 controls each unit of the vehicle 10 based on the driving plan. The control device 12 generates a steering signal for control of the steering device 14 that controls the steering wheel of the vehicle 10, based on the driving plan. The control device 12 generates a driving signal that controls a drive unit 15 such as an engine or motor of the vehicle 10, based on the driving plan. The control device 12 also generates a braking signal that controls the braking device 16 of the vehicle 10, based on the driving plan. The control device 12 outputs the steering signal, driving signal or braking signal to the steering device 14, drive unit 15 or braking device 16, via the in-vehicle network 17.

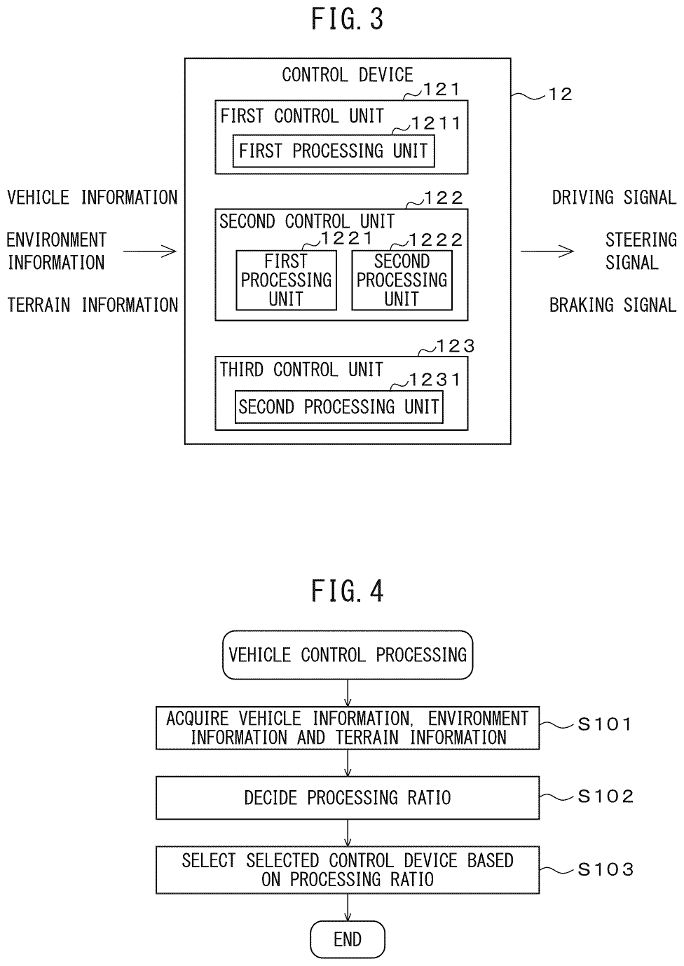

FIG. 3 is a diagram illustrating the control device 12. The first processing unit 12A of the control device 12 has a plurality of first processing units 1211, 1221. The second processing unit 12B of the control device 12 has a plurality of second processing units 1222, 1231. Each of the first processing units 1211 and the second processing unit 1231 may constitute an End-to-End model, for example, which outputs the steering signal, driving signal or braking signal based on vehicle information, environment information and terrain information. The first processing unit 1221 may carry out processing to generate a driving plan (described below) based on vehicle information, environment information and terrain information, and the second processing unit 1222 may carry out processing to output a steering signal, driving signal or braking signal based on the driving plan.

The control device 12 has a first control unit 121, a second control unit 122 and a third control unit 123. The first control unit 121 generates an output signal using only the first processing unit 1211. The second control unit 122 has a first processing unit 1211 that generates output signals using only a machine learning-trained classifier, and a second processing unit 1222 that generates output signals without using a machine learning-trained classifier. The third control unit 123 generates an output signal using only the second processing unit 1231. The average power consumption by the first control unit 121 is greater than that of the second control unit 122. The average power consumption by the third control unit 123 is less than that of the second control unit 122.

The decision device 13 selects a selected control unit for control of the vehicle 10, from among the first control unit 121, second control unit 122 and third control unit 123. The control device 12 inputs vehicle information, environment information and terrain information, and outputs a driving signal, steering signal and braking signal using the selected control unit. The control device 12 may also output other information or signals such as information for notifying the driver, in addition to the driving signal, steering signal and braking signal.

The first control unit 121, second control unit 122 and third control unit 123 may each operate on different semiconductor devices. The semiconductor devices other than that of the selected control unit that has been selected by the decision device 13 may be operated in standby power mode, or their power supply may be stopped. This can reduce power consumption by the control device 12.

The decision device 13 carries out decision processing, selection processing and switch processing. For this purpose, the decision device 13 has a communication interface (IF) 21, a memory 22 and a processor 23. The communication interface 21, memory 22 and processor 23 are connected via signal wires 24. The communication interface 21 has an interface circuit to connect the decision device 13 with the in-vehicle network 17.

The memory 22 is an example of a storage unit, and it has a volatile semiconductor memory and a non-volatile semiconductor memory, for example. The memory 22 stores an application computer program and various data to be used for information processing carried out by the processor 23 of each device.

All or some of the functions of the decision device 13 are functional modules driven by a computer program operating on the processor 23, for example. The processor 23 has a deciding unit 231, a selection unit 232 and a switching unit 233. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphics processing unit. The decision device 13 is an electronic control unit (ECU), for example. The deciding unit 231 is an example of the first deciding unit and second deciding unit.

For FIG. 2, the control device 12 and the decision device 13 were described as separate devices, but these may also be constructed as a single device. Specifically, the first processing unit 12A and second processing unit 12B may be constructed as different devices from the decision device 13, or the first processing unit 12A and second processing unit 12B may be constructed in the same device as the decision device 13.

FIG. 4 is an example of an operation flow chart for vehicle control processing by the decision device 13. Vehicle control processing by the decision device 13 will be described with reference to FIG. 4. The decision device 13 carries out vehicle control processing according to the operation flow chart shown in FIG. 4, at a vehicle control time having a predetermined cycle.

First, the deciding unit 231 acquires vehicle information, environment information and terrain information (step S101). The vehicle information, environment information and terrain information are input to the decision device 13 through the in-vehicle network 17.

The deciding unit 231 then decides the processing ratio for the control device 12 based on one or more information types from among the vehicle information, environment information and terrain information (step S102). The control device 12 is able to vary the processing ratio between the portion processed by the first processing unit 12A and the portion processed by the second processing unit 12B.

For this embodiment, if the portion processed by the first processing unit 12A is 100% and the portion processed by the second processing unit 12B is 0%, then the processing ratio is 1:0. If the portion processed by the first processing unit 12A is 0% and the portion processed by the second processing unit 12B is 100%, then the processing ratio is 0:1. If the portion processed by the first processing unit 12A is 50% and the portion processed by the second processing unit 12B is 50%, then the processing ratio is 0.5:0.5. The processing ratio may also be a different ratio such as 0.3:0.7 or 0.7:0.3, for example.

The processing ratio is thus decided within the range of 1:0 to 0:1. That the processing ratio is 0.5:0.5, for example, means that the ratio of the average power consumption by operation of the first processing unit 12A and the average power consumption by operation of the second processing unit 12B is 0.5:0.5.

That the processing ratio is 1:0, for example, means that the ratio of the average power consumption by operation of the first processing unit 12A and the average power consumption by operation of the second processing unit 12B is 1:0. The average standby power when the first processing unit 12A or second processing unit 12B is essentially not operated may be considered to be essentially 0.

That the processing ratio is 0:1, for example, means that the ratio of the average power consumption by operation of the first processing unit 12A and the average power consumption by operation of the second processing unit 12B is 0:1. Here as well, the average standby power when the first processing unit 12A or second processing unit 12B is essentially not operated may be considered to be essentially 0.

For this embodiment, the deciding unit 231 decides the processing ratio from among 1:0, 0.5:0.5 and 0:1.

The selection unit 232 then selects a selected control unit to control the vehicle 10, from among the first control unit 121, second control unit 122 and third control unit 123, based on the processing ratio decided by the deciding unit 231 (step S103), and the series of processing steps is complete.

When the processing ratio is 1:0, the selection unit 232 selects the first control unit 121 as the selected control unit. When the processing ratio is 0.5:0.5, the selection unit 232 selects the second control unit 122 as the selected control unit. When the processing ratio is 0:1, the selection unit 232 selects the third control unit 123 as the selected control unit. With the second control unit 122, the ratio between the average power consumption by operation of the first processing unit 1221 and the average power consumption by operation of the second processing unit 1222 is 0.5:0.5.

When the control device 12 has a selected control unit corresponding to another processing ratio (such as 0.7:0.3 or 0.3:0.7), the deciding unit 231 decides on a processing ratio from among 1:0, 0.7:0.3, 0.5:0.5, 0.3:0.7 and 0:1.

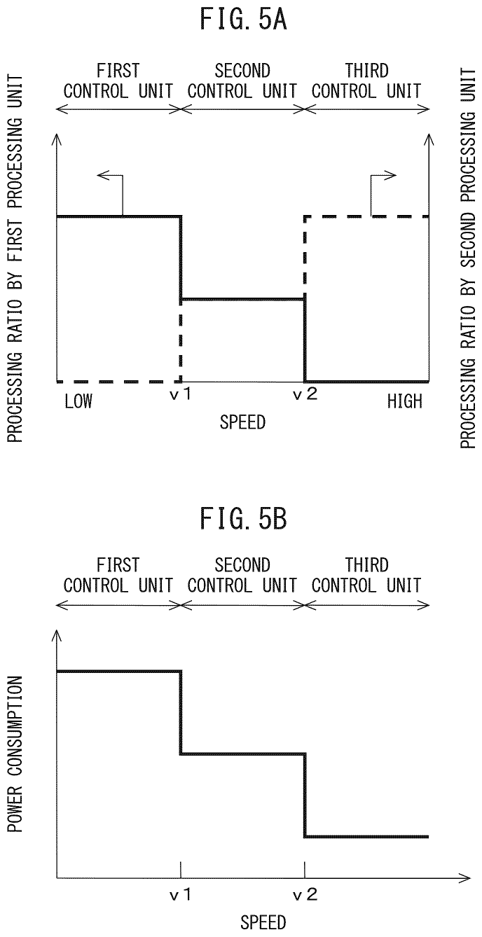

An example of deciding the processing ratio based on vehicle information, environment information and terrain information will now be explained with reference to FIGS. 5A to 8B.

FIG. 5A is a diagram illustrating decision on processing ratio based on vehicle information, and FIG. 5B is a diagram illustrating the relationship between vehicle information and power consumption.

The vehicle information includes information representing the degree of operation of the vehicle 10. For example, the vehicle information includes the speed of the vehicle 10, the amount of change in the steering angle per unit time, the number of brakings per unit time, and the drivable distance. The deciding unit 231 decides the processing ratio according to the degree of operation of the vehicle 10.

The deciding unit 231 decides on a processing ratio such that the portion processed by the first processing unit 12A is greater than the portion processed by the second processing unit 12B, for a slower speed of the vehicle 10 compared to a faster speed of the vehicle 10.

The deciding unit 231 decides on a processing ratio such that the portion processed by the first processing unit 12A is greater than the portion processed by the second processing unit 12B, for a greater amount of change in steering angle per unit time compared to a smaller amount of change in steering angle per unit time.

The deciding unit 231 decides on a processing ratio such that the portion processed by the first processing unit 12A is greater than the portion processed by the second processing unit 12B, for more brakings per unit time than for fewer brakings per unit time.

The deciding unit 231 decides on a processing ratio such that the portion processed by the first processing unit 12A is greater than the portion processed by the second processing unit 12B, for a longer drivable distance than for a shorter drivable distance. The drivable distance is calculated based on information representing the amount of electric storage or fuel remaining and the electricity consumption or fuel consumption of the vehicle 10.

FIG. 5A and FIG. 5B show examples where the vehicle information is the speed of the vehicle 10. The speed of the vehicle 10 may be the average speed of the vehicle 10 during the most recent predetermined period, for example.

For this embodiment, when the speed of the vehicle 10 is slower than a first reference speed v1, the deciding unit 231 decides on a processing ratio of 1:0. When the speed of the vehicle 10 is faster than a second reference speed v2, the deciding unit 231 decides on a processing ratio of 0:1. When the speed of the vehicle 10 is equal to or greater than the first reference speed v1 and equal to or less than the second reference speed v2, the deciding unit 231 decides on a processing ratio of 0.5:0.5.

As shown in FIG. 5A, the selection unit 232 selects the first control unit 121 as the selected control unit when the processing ratio is 1:0. When the processing ratio is 0.5:0.5, the selection unit 232 selects the second control unit 122 as the selected control unit. When the processing ratio is 0:1, the selection unit 232 selects the third control unit 123 as the selected control unit.

As shown in FIG. 5B, when the speed of the vehicle 10 is slower than the first reference speed v1, power consumption by the control device 12 is highest. When the speed of the vehicle 10 is faster than the second reference speed v2, power consumption by the control device 12 is lowest. When the speed of the vehicle 10 is equal to or greater than the first reference speed v1 and equal to or less than the second reference speed v2, power consumption by the control device 12 is medium.

As mentioned above, when the speed of the vehicle 10 is slower than the first reference speed, the vehicle 10 may be traveling on a city road. City roads have more moving objects such as other vehicles and pedestrians. The vehicle 10 is also controlled in response to intersections and traffic lights on city roads. In some embodiments, when the speed of the vehicle 10 is slow, therefore, the control device 12 may be able to safely control the vehicle in response to complex environment or terrain.

When the speed of the vehicle 10 is faster than the second reference speed v2, on the other hand, the vehicle 10 may be traveling on a motorway. There are no traffic lights or pedestrians on motorways. In addition, motorways tend to have straight roads and terrain with few branches or merges. When the speed of the vehicle 10 is fast, therefore, it is sufficient for the control device 12 to be able to safely control the vehicle in response to relatively simple environment and terrain.

Therefore when the speed of the vehicle 10 is slower than the first reference speed v1, the first control unit 121 is selected and the processing ratio for processing by the first processing unit 12A is increased, thereby ensuring safety. When the speed of the vehicle 10 is faster than the second reference speed v2, on the other hand, the third control unit 123 is selected and the processing ratio for processing by the second processing unit 12B is increased, thereby reducing power consumption.

When the speed of the vehicle 10 is equal to or greater than the first reference speed v1 and equal to or less than the second reference speed v2, the vehicle 10 may be traveling on a suburban road. On a suburban road, the number of moving objects around the vehicle 10 is not so large, and the road conditions are not so complex.

Therefore when the speed of the vehicle 10 is equal to or greater than the first reference speed v1 and equal to or less than the second reference speed v2, the second control unit 122 is selected so as to moderately ensure safety while moderately reducing power consumption.

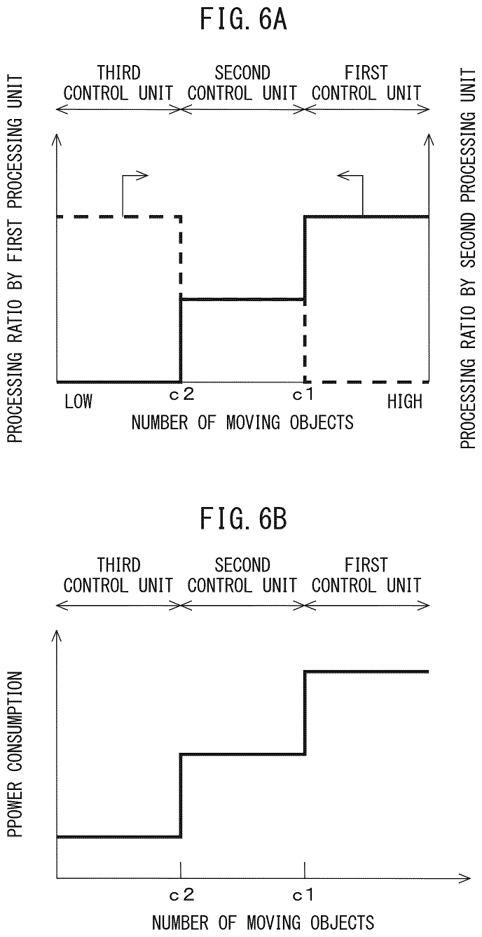

FIG. 6A is a diagram illustrating decision on processing ratio based on environment information, and FIG. 6B is a diagram illustrating the relationship between environment information and power consumption.

Environment information includes information representing the degree of complexity of the surrounding environment of the vehicle 10. For example, the environment information includes the number of moving objects around the vehicle 10, the number of road features around the vehicle 10, and the amount of precipitation around the vehicle 10. A greater number of moving objects, a greater number of road features or a larger amount of precipitation creates a higher degree of complexity of the environment surrounding the vehicle 10.

The deciding unit 231 decides on a processing ratio such that the portion processed by the first processing unit 12A is greater than the portion processed by the second processing unit 12B, for a more complex environment surrounding the vehicle 10 than for a less complex environment surrounding the vehicle 10.

FIG. 6A and FIG. 6B show examples where the environment information is the number of moving objects. The deciding unit 231 acquires the number of moving objects around the vehicle 10 from the control device 12, via the in-vehicle network 17.

For this embodiment, when the number of moving objects is greater than a first reference number c1, the deciding unit 231 decides on a processing ratio of 1:0. When the number of moving objects is less than a second reference number c2, the deciding unit 231 decides on a processing ratio of 0:1. When the number of moving objects is equal to or less than the first reference number c1 and equal to or greater than the second reference number c2, the deciding unit 231 decides on a processing ratio of 0.5:0.5.

As shown in FIG. 6A, the selection unit 232 selects the first control unit 121 as the selected control unit when the processing ratio is 1:0. When the processing ratio is 0.5:0.5, the selection unit 232 selects the second control unit 122 as the selected control unit. When the processing ratio is 0:1, the selection unit 232 selects the third control unit 123 as the selected control unit.

As shown in FIG. 6B, when the number of moving objects is greater than the first reference number c1, power consumption by the control device 12 is highest. When the number of moving objects is less than the second reference number c2, power consumption by the control device 12 is lowest. When the number of moving objects is equal to or less than the first reference number c1 and equal to or greater than the second reference number c2, power consumption by the control device 12 is medium.

When the number of moving objects is greater than the first reference number c1, a large number of moving objects are moving around the vehicle 10. In some embodiments, in an environment with high traffic volume and many obstacles, the vehicle 10 is controlled so as to avoid approaching other objects. The vehicle 10 may be traveling on a road in a commercial area, on a school route, or in a region where an event is being held. In some embodiments, when the number of moving objects is greater than the first reference number c1, the control device 12 may be able to safely control the vehicle in response to the complex environment.

When the number of moving objects is less than the second reference number c2, on the other hand, large numbers of moving objects are not present around the vehicle 10. The vehicle 10 may be traveling on a road during early morning or night, or in a wide parking lot. It is sufficient if the control device 12 can safely control the vehicle in response to a relatively simple environment.

Therefore when the number of moving objects is greater than the first reference number c1, the first control unit 121 is selected and the processing ratio for processing by the first processing unit 12A is increased, thereby ensuring safety. When the number of moving objects is less than the second reference number c2, on the other hand, the third control unit 123 is selected and the processing ratio for processing by the second processing unit 12B is increased, thereby reducing power consumption.

In some embodiments, when the number of moving objects is equal to or less than the first reference number c1 and equal to or greater than the second reference number c2, the vehicle 10 is controlled so as to avoid approaching other objects in an environment with relatively low traffic volume and few obstacles. The vehicle 10 may be traveling during the day on a general road.

Therefore when the number of moving objects is equal to or less than the first reference number cl and equal to or greater than the second reference number c2, the second control unit 122 is selected so as to moderately ensure safety while moderately reducing power consumption.

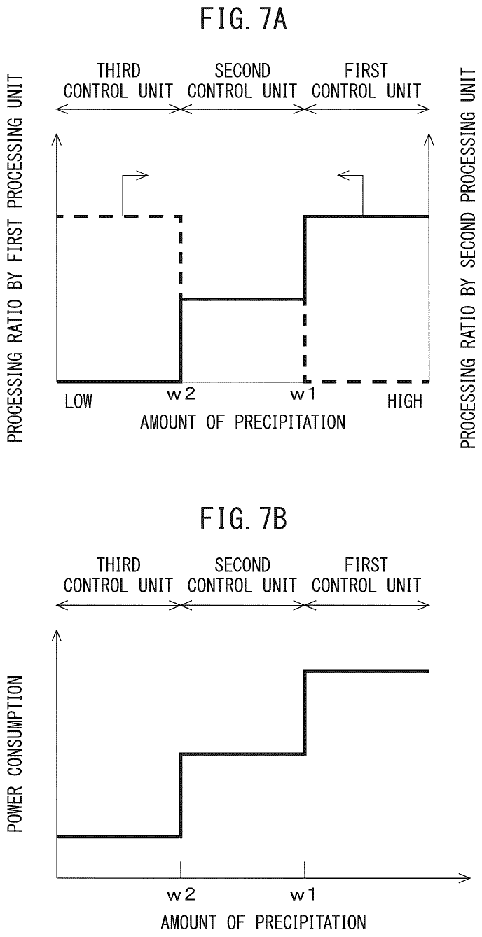

FIG. 7A and FIG. 7B show examples where the environment information is the amount of precipitation. The deciding unit 231 acquires the amount of precipitation around the vehicle 10 from the sensor group 3, via the in-vehicle network 17. The deciding unit 231 may also acquire the amount of precipitation around the vehicle 10 from the communication network via the communication device 2.

For this embodiment, when the amount of precipitation is greater than a first reference value w1, the deciding unit 231 decides on a processing ratio of 1:0. When the amount of precipitation is less than a second reference value w2, the deciding unit 231 decides on a processing ratio of 0:1. An amount of precipitation of less than the second reference value w2 includes cases where rain or snow is not falling. When the amount of precipitation is equal to or less than the first reference value w1 and equal to or greater than the second reference value w2, the deciding unit 231 decides on a processing ratio of 0.5:0.5.

As shown in FIG. 7A, the selection unit 232 selects the first control unit 121 as the selected control unit when the processing ratio is 1:0. When the processing ratio is 0.5:0.5, the selection unit 232 selects the second control unit 122 as the selected control unit. When the processing ratio is 0:1, the selection unit 232 selects the third control unit 123 as the selected control unit.

As shown in FIG. 7B, when the amount of precipitation is greater than the first reference value w1, power consumption by the control device 12 is highest. When the amount of precipitation is less than the second reference value w2, power consumption by the control device 12 is lowest. When the amount of precipitation is equal to or less than the first reference value w1 and equal to or greater than the second reference value w2, power consumption by the control device 12 is medium.

When the amount of precipitation is greater than the first reference value w1, this means that a high amount of rain or snow is falling around the vehicle 10. When raindrops adhere to a sensor of the sensor group 3, this interferes with accurate detection of the environment surrounding the vehicle 10. More accurate control of the vehicle 10 is also desirable for traveling of the vehicle 10 on road surfaces wetted by rain or road surfaces with accumulated snow. In some embodiments, when the amount of precipitation is greater than the first reference value w1, the control device 12 may be able to safely control the vehicle in response to the complex environment.

When the amount of precipitation is less than the second reference value w2, on the other hand, the sensors of the sensor group 3 of the vehicle 10 are able to accurately detect the environment surrounding the vehicle 10. The road surface is dry but may also be slightly wet. It is sufficient if the control device 12 can safely control the vehicle in response to a relatively simple environment.

Therefore when the amount of precipitation is greater than the first reference value w1, the first control unit 121 is selected and the processing ratio for processing by the first processing unit 12A is increased, thereby ensuring safety. When the amount of precipitation is less than the second reference value w2, on the other hand, the third control unit 123 is selected and the processing ratio for processing by the second processing unit 12B is increased, thereby reducing power consumption.

When the amount of precipitation is equal to or less than the first reference value w1 and equal to or greater than the second reference value w2, the vehicle 10 has a relatively low amount of rain or snow falling around the vehicle 10. The sensors of the sensor group 3 can detect the environment surrounding the vehicle 10 with relative accuracy. The state of the road surface may be relatively not poor.

Therefore when the amount of precipitation is equal to or less than the first reference value w1 and equal to or greater than the second reference value w2, the second control unit 122 is selected so as to moderately ensure safety while moderately reducing power consumption.

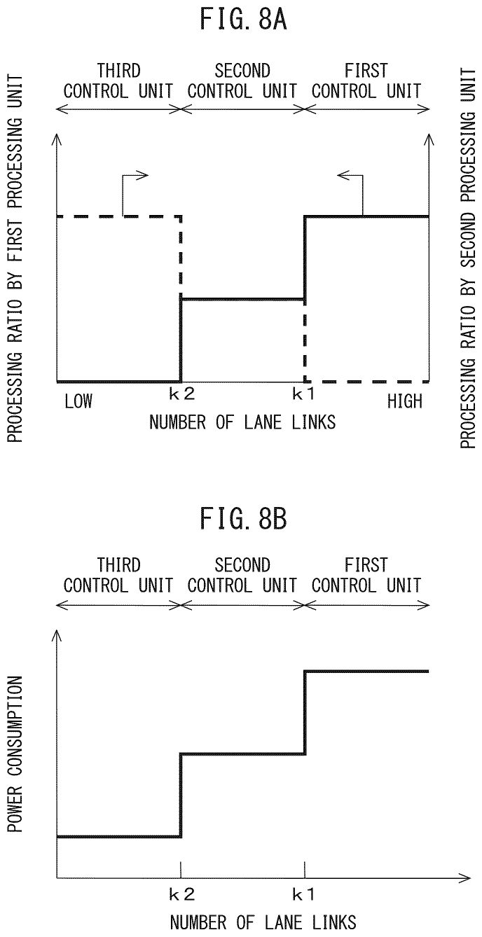

FIG. 8A is a diagram illustrating decision on processing ratio based on terrain information, and FIG. 8B is a diagram illustrating the relationship between terrain information and power consumption.

Terrain information includes information representing the degree of complexity of the terrain that includes the current location of the vehicle 10. For example, the terrain information includes the number of lane links around the vehicle 10, the curvature of the road and the gradient of the road. A greater number of lane links, a lower curvature of the road or a higher gradient of the road corresponds to higher complexity of the terrain which includes the current location of the vehicle 10. The number of lane links around the vehicle 10, the curvature of the road and the gradient of the road are acquired based on map information, for example.

The deciding unit 231 decides on a processing ratio such that the portion processed by the first processing unit 12A is greater than the portion processed by the second processing unit 12B, for a more complex terrain than for a less complex terrain.

FIG. 8A and FIG. 8B show examples where the terrain information is the number of lane links around the vehicle 10. On a road with many lanes, or near an intersection, the number of lane links around the vehicle 10 is increased. The deciding unit 231 acquires the number of lane links around the vehicle 10 from map information. The deciding unit 231 may also acquire the number of lane links calculated by the control device 12 based on a camera image, via the in-vehicle network 17.

For this embodiment, when the number of lane links is greater than a first reference value k1, the deciding unit 231 decides on a processing ratio of 1:0. When the number of lane links is less than a second reference value k2, the deciding unit 231 decides on a processing ratio of 0:1. When the number of lane links is equal to or less than the first reference value k1 and equal to or greater than the second reference value k2, the deciding unit 231 decides on a processing ratio of 0.5:0.5.

As shown in FIG. 8A, the selection unit 232 selects the first control unit 121 as the selected control unit when the processing ratio is 1:0. When the processing ratio is 0.5:0.5, the selection unit 232 selects the second control unit 122 as the selected control unit. When the processing ratio is 0:1, the selection unit 232 selects the third control unit 123 as the selected control unit.

As shown in FIG. 8B, when the number of lane links is greater than the first reference value k1, power consumption by the control device 12 is highest. When the number of lane links is less than the second reference value k2, power consumption by the control device 12 is lowest. When the number of lane links is equal to or less than the first reference value k1 and equal to or greater than the second reference value k2, power consumption by the control device 12 is medium.

When the number of lane links is greater than the first reference value k1, the vehicle 10 may be traveling on a road with many lanes or near an intersection. Numerous vehicles or pedestrians may be present around the vehicle 10. Depending on the intersection, the condition of a traffic light signal may change in a complex manner. The vehicle 10 may also be traveling in the center or commercial area of a large city. In some embodiments, when the number of lane links is greater than the first reference value k1, the control device 12 may be able to safely control the vehicle in response to the complex environment and terrain.

When the number of lane links is less than the second reference value k2, on the other hand, the vehicle 10 may be traveling on a road with few lanes or on a road away from intersections. The vehicle 10 may also be traveling on a high-speed road or on a straight road in the suburbs. When the number of lane links is less than the second reference value k2, it is sufficient for the control device 12 to be able to safely control the vehicle in response to a relatively simple environment and terrain.

Therefore when the number of lane links is greater than the first reference value k1, the first control unit 121 is selected and the processing ratio for processing by the first processing unit 12A is increased, thereby ensuring safety. When the number of lane links is less than the second reference value k2, on the other hand, the third control unit 123 is selected and the processing ratio for processing by the second processing unit 12B is increased, thereby reducing power consumption.

When the number of lane links is equal to or less than the first reference value k1 and equal to or greater than the second reference value k2, the vehicle 10 may be traveling on a road in a residential area or on a city road. Roads in residential areas and city roads are roads whose conditions are also not very complex.

Therefore when the number of lane links is equal to or less than the first reference value k1 and equal to or greater than the second reference value k2, the second control unit 122 is selected so as to moderately ensure safety while moderately reducing power consumption.

In the above explanation, the processing ratio was decided based on one type of information from among vehicle information, environment information and terrain information, but the processing ratio may also be decided based on multiple types of information from among vehicle information, environment information and terrain information. For example, a table representing relationships between the speed of the vehicle 10 and the number of moving objects, and the selected control device, may be used to decide the processing ratio based on the speed of the vehicle 10 and the number of moving objects.

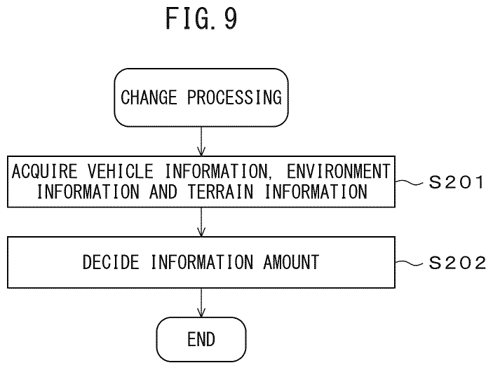

FIG. 9 is an example of an operation flow chart for change processing by the decision device 13. Change processing by the decision device 13 will be described with reference to FIG. 9. The decision device 13 carries out change processing according to the operation flow chart shown in FIG. 9, at a change time having a predetermined cycle.

First, the deciding unit 231 acquires vehicle information, environment information and terrain information (step S201). The vehicle information, environment information and terrain information are input to the decision device 13 through the in-vehicle network 17.

The deciding unit 231 then decides the information amount to be input into the selected control unit which has been selected by the selection unit 232, based on at least one type of information from among vehicle information, environment information and terrain information (step S202).

The vehicle information used may be information representing the degree of operation of the vehicle 10 as described above. The environment information used may be information representing the degree of complexity of the environment surrounding the vehicle 10. The terrain information used may be information representing the degree of complexity of the terrain including the current location of the vehicle 10.

By reducing the amount of information input to the selected first control unit 121, second control unit 122 or third control unit 123, it is possible to reduce the electric power used for operation of the control device 12.

The amount of information may include the number of sensors through which the detected information is input to the selected control unit, the resolution of the images input to the selected control unit, or the detection frequency by the sensors through which the detected information is input to the selected control unit.

The deciding unit 231 changes the amount of information input to the selected control unit by changing the number of sensors. The sensor group 3 mentioned above has a front sensor, ambient sensor, rear sensor and side sensor. A priority value is set for each of these sensors. The priority for the front sensor is 4, the priority for the ambient sensor is 3, the priority for the rear sensor is 2 and the priority for the side sensor is 1. The priority is higher for a higher number.

Detection information from a sensor with at least priority 4 is necessary for traveling of the vehicle 10. By adding detection information from a sensor of lower priority to detection information from a sensor with priority 4, it is possible to more safely control the vehicle 10 depending on the conditions.

The deciding unit 231 then decides the information amount for the sensor based on at least one type of information from among vehicle information, environment information and terrain information. Detection information from the sensors is input to the selected control unit according to the information amount of each sensor.

The deciding unit 231 decides on the amount of information for the sensor based on information representing the degree of operation of the vehicle 10. The deciding unit 231 also decides on the amount of information for the sensor based on the degree of complexity of the environment surrounding the vehicle 10. The deciding unit 231 also decides on the amount of information for the sensor based on the degree of complexity of the terrain which includes the current location of the vehicle 10. A higher amount of information of the sensor is decided for a higher degree of difficulty for driving the vehicle 10.

For example, when the amount of information of the sensor is 4, the information detected by the sensors of all priority levels is input into the selected control unit. Specifically, information detected by the front sensor, ambient sensor, rear sensor and side sensor is input into the selected control unit. When the amount of information of the sensor is 3, the information detected by the sensors of priority level 2 and higher is input into the selected control unit.

Specifically, information detected by the front sensor, ambient sensor and rear sensor is input into the selected control unit. When the amount of information of the sensor is 2, the information detected by the sensors of priority level 3 and higher is input into the selected control unit. Specifically, information detected by the front sensor and ambient sensor is input into the selected control unit. When the amount of information of the sensor is 1, the information detected by the sensors of priority level 4 and higher is input into the selected control unit. Specifically, only information detected by the front sensor is input into the selected control unit.

The deciding unit 231 also changes the amount of information input to the selected control unit by changing the resolution of images input to the selected control unit. The front camera and rear camera can change the resolution of their acquired images. Using images with higher resolution allows more accurate detection of the environment surrounding the vehicle 10, and thus increases the safety of the vehicle 10.

The deciding unit 231 then decides the resolution for acquired images based on at least one type of information from among vehicle information, environment information and terrain information.

The deciding unit 231 decides on the resolution for acquired images based on information representing the degree of operation of the vehicle 10. The deciding unit 231 also decides on the resolution for acquired images based on the degree of complexity of the environment surrounding the vehicle 10. The deciding unit 231 also decides on the resolution for acquired images based on the degree of complexity of the terrain that includes the current location of the vehicle 10.

The deciding unit 231 notifies the sensor group 3 of the decided image resolution. The front camera and rear camera acquire images at the notified resolution.

The deciding unit 231 also decides the detection frequency for sensors whose detected information is to be input into the selected control unit, based on at least one type of information from among vehicle information, environment information and terrain information. When the sensor is a front camera or rear camera, the detection frequency corresponds to the frame rate. Since a higher detection frequency allows more accurate detection of the environment surrounding the vehicle 10, the safety of the vehicle 10 is increased. In the case of a LiDAR sensor, millimeter wave radar or ultrasonic sensor, the detection frequency corresponds to the cycle at which the reflected wave information is acquired.

The deciding unit 231 decides on the detection frequency for the sensor based on information representing the degree of operation of the vehicle 10. The deciding unit 231 also decides on the detection frequency for the sensor based on the degree of complexity of the environment surrounding the vehicle 10. The deciding unit 231 also decides on the detection frequency for the sensor based on the degree of complexity of the terrain which includes the current location of the vehicle 10.

The deciding unit 231 notifies the sensor group 3 of the decided detection frequency. Each sensor of the sensor group 3 detects information at a cycle corresponding to the detection frequency notified by the deciding unit 231.

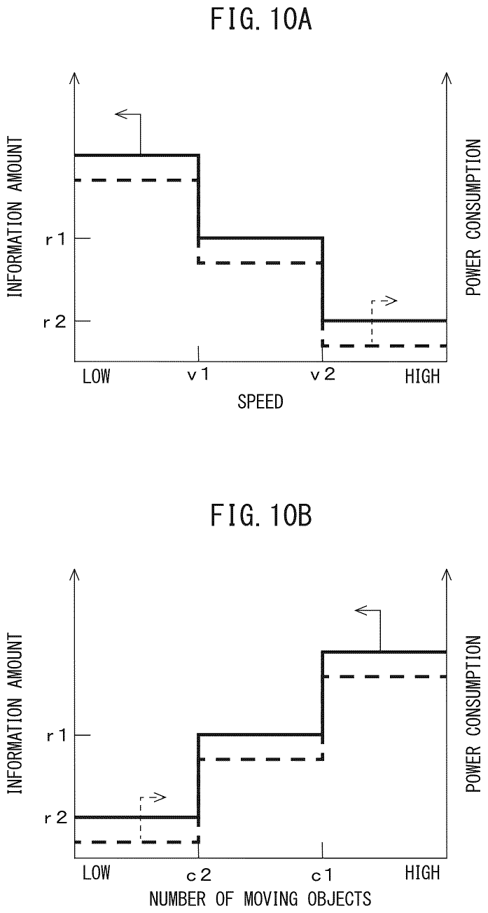

FIG. 10A is a diagram illustrating decision on information amount based on vehicle information. The vehicle information here is the speed of the vehicle 10.

According to this embodiment, when the speed of the vehicle 10 is slower than the first reference speed v1, the deciding unit 231 decides on an amount of information greater than a first reference value r1 to be input to the selected control unit. When the speed of the vehicle 10 is faster than the second reference speed v2, the deciding unit 231 decides on an amount of information less than a second reference value r2 to be input to the selected control unit. When the speed of the vehicle 10 is equal to or greater than the first reference speed v1 and equal to or less than the second reference speed v2, the deciding unit 231 decides on an information amount that is equal to or less than the first reference value r1 and equal to or greater than the second reference value r2, to be input to the selected control unit.

When the speed of the vehicle 10 is slower than the first reference speed v1, power consumption by the selected control unit is highest, when the speed of the vehicle 10 is faster than the second reference speed v2, power consumption by the selected control unit is lowest, and when the speed of the vehicle 10 is equal to or greater than the first reference speed v1 and equal to or less than the second reference speed v2, power consumption by the selected control unit is medium.

When the amount of information corresponds to the number of sensors, the first reference value r1 and second reference value r2 correspond to the information amounts of the sensors, the information amount of the sensor for the first reference value r1 being higher than the information amount of the sensor for the second reference value r2.

When the amount of information corresponds to the resolution of the image, the first reference value r1 and second reference value r2 correspond to resolution, the resolution of the first reference value being higher than the resolution of the second reference value r2.

When the amount of information corresponds to the detection frequency of the sensor, the first reference value r1 and second reference value r2 correspond to detection frequency, the detection frequency of the first reference value r1 being higher than the detection frequency of the second reference value r2.

When the speed of the vehicle 10 is slower than the first reference speed, the vehicle 10 may be traveling on a city road. City roads have more moving objects such as other vehicles and pedestrians. The vehicle 10 is also controlled in response to intersections and traffic lights on city roads. In some embodiments, when the speed of the vehicle 10 is slow, a greater amount of information than the first reference value r1 is input to the selected control unit, allowing the vehicle to be safely controlled.

When the speed of the vehicle 10 is faster than the second reference speed v2, on the other hand, the vehicle 10 may be traveling on a motorway. There are no traffic lights or pedestrians on motorways. In addition, motorways tend to have straight roads and terrain with few branches or merges. When the speed of the vehicle 10 is fast, a lower amount of information than the second reference value r2 is input to the selected control unit, thus reducing power consumption.

When the speed of the vehicle 10 is equal to or greater than the first reference speed v1 and equal to or less than the second reference speed v2, the vehicle 10 may be traveling on a suburban road. On a suburban road, the number of moving objects around the vehicle 10 is not so large, and the road conditions are not so complex.

Therefore when the speed of the vehicle 10 is equal to or greater than the first reference speed v1 and equal to or less than the second reference speed v2, an amount of information that is equal to or less than the first reference value r1 and equal to or greater than the second reference value r2 is input to the selected control unit, so as to moderately ensure safety while reducing power consumption.

The priority level of the sensor may be set according to the detection range from the vehicle 10. In this case, when the speed of the vehicle 10 is slow, the priority of sensors that detect objects near the vehicle 10 may be increased, and when the speed of the vehicle 10 is fast, the priority of sensors that detect objects far from the vehicle 10 may be increased.

FIG. 10B is a diagram illustrating decision on information amount based on environment information. The environment information here is the number of moving objects around the vehicle 10.

According to this embodiment, when the number of moving objects around the vehicle 10 is greater than the first reference number c1, the deciding unit 231 decides on an amount of information greater than the first reference value r1 to be input to the selected control unit. When the number of moving objects around the vehicle 10 is less than the second reference number c2, the deciding unit 231 decides on an amount of information less than the second reference value r2 to be input to the selected control unit. When the number of moving objects around the vehicle 10 is equal to or less than the first reference number c1 and equal to or greater than the second reference number c2, the deciding unit 231 decides on an information amount that is equal to or less than the first reference value r1 and equal to or greater than the second reference value r2, to be input to the selected control unit.

When the number of moving objects around the vehicle 10 is greater than the first reference number c1, power consumption by the selected control unit is highest, when the number of moving objects around the vehicle 10 is less than the second reference number c2, power consumption by the selected control unit is lowest, and when the number of moving objects around the vehicle 10 is equal to or less than the first reference number c1 and equal to or greater than second reference number c2, power consumption by the selected control unit is medium.

When the amount of information corresponds to the number of sensors, the first reference value r1 and second reference value r2 correspond to the information amounts of the sensors, the information amount of the sensor for the first reference value r1 being higher than the information amount of the sensor for the second reference value r2.

When the amount of information corresponds to the resolution of the image, the first reference value r1 and second reference value r2 correspond to resolution, the resolution of the first reference value being higher than the resolution of the second reference value r2.

When the amount of information corresponds to the detection frequency of the sensor, the first reference value r1 and second reference value r2 correspond to detection frequency, the detection frequency of the first reference value r1 being higher than the detection frequency of the second reference value r2.

When the number of moving objects around the vehicle 10 is greater than the first reference number c1, a large number of moving objects are moving around the vehicle 10. In some embodiments, in an environment with high traffic volume and many obstacles, the vehicle 10 is controlled so as to avoid approaching other objects. The vehicle 10 may be traveling on a road in a commercial area, on a school route, or in a region where an event is being held. In some embodiments, when the number of moving objects is greater than the first reference number c1, a greater amount of information than the first reference value r1 is input to the selected control unit, allowing the vehicle to be safely controlled.

When the number of moving objects around the vehicle 10 is less than the second reference number c2, on the other hand, large numbers of moving objects are not present around the vehicle 10. The vehicle 10 may be traveling on a road during early morning or night, or in a wide parking lot. When the number of moving objects is less than the second reference number c2, the control device 12 may input an amount of information less than the second reference value r2 to the selected control unit, allowing the vehicle to be safely controlled.

In some embodiments, when the number of moving objects is equal to or less than the first reference number c1 and equal to or greater than the second reference number c2, the vehicle 10 is controlled so as to avoid approaching other objects in an environment with relatively low traffic volume and few obstacles. The vehicle 10 may be traveling during the day on a general road.

Therefore when the number of moving objects is equal to or less than the first reference number c1 and equal to or greater than the second reference number c2, an amount of information that is equal to or less than the first reference value r1 and equal to or greater than the second reference value r2 is input to the selected control unit, so as to moderately ensure safety while reducing power consumption.

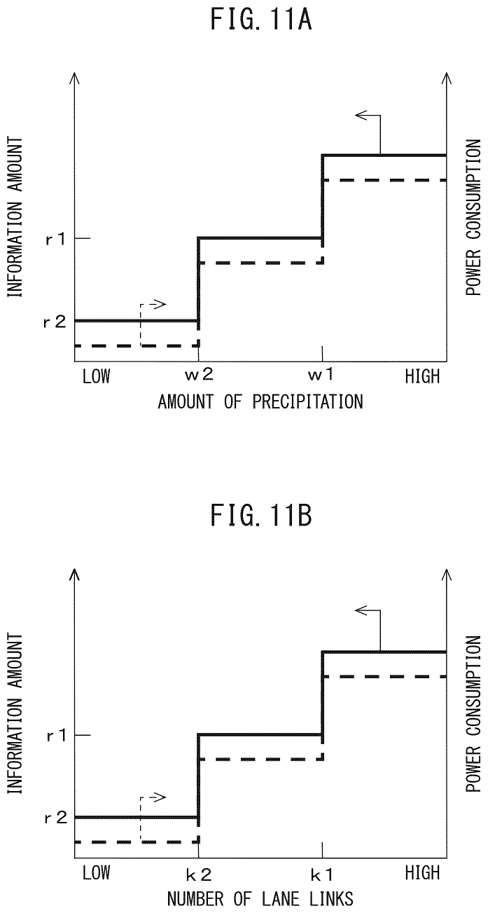

FIG. 11A is another diagram illustrating decision on information amount based on environment information. The environment information here is the amount of precipitation around the vehicle 10.

According to this embodiment, when the amount of precipitation around the vehicle 10 is greater than the first reference value w1, the deciding unit 231 decides on an amount of information greater than a first reference value r1 to be input to the selected control unit. When the amount of precipitation around the vehicle 10 is less than the second reference value w2, the deciding unit 231 decides on an amount of information less than the second reference value r2 to be input to the selected control unit. When the amount of precipitation around the vehicle 10 is equal to or less than the first reference value w1 and equal to or greater than the second reference value w2, the deciding unit 231 decides on an information amount that is equal to or less than the first reference value r1 and equal to or greater than the second reference value r2, to be input to the selected control unit.

When the amount of precipitation around the vehicle 10 is greater than the first reference value w1, power consumption by the selected control unit is highest, when the amount of precipitation around the vehicle 10 is less than the second reference value w2, power consumption by the selected control unit is lowest, and when the amount of precipitation around the vehicle 10 is equal to or less than the first reference value w1 and equal to or greater than second reference value w2, power consumption by the selected control unit is medium.

When the amount of information corresponds to the number of sensors, the first reference value r1 and second reference value r2 correspond to the information amounts of the sensors, the information amount of the sensor for the first reference value r1 being higher than the information amount of the sensor for the second reference value r2.

When the amount of information corresponds to the resolution of the image, the first reference value r1 and second reference value r2 correspond to resolution, the resolution of the first reference value being higher than the resolution of the second reference value r2.

When the amount of information corresponds to the detection frequency of the sensor, the first reference value r1 and second reference value r2 correspond to detection frequency, the detection frequency of the first reference value r1 being higher than the detection frequency of the second reference value r2.

When the amount of precipitation is greater than the first reference value w1, this means that a high amount of rain or snow is falling around the vehicle 10. When raindrops adhere to a sensor of the sensor group 3, this interferes with accurate detection of the environment surrounding the vehicle 10. More accurate control of the vehicle 10 is also desirable for traveling of the vehicle 10 on road surfaces wetted by rain or road surfaces with accumulated snow. In some embodiments, when the amount of precipitation is greater than the first reference value w1, a greater amount of information than the first reference value r1 is input to the selected control unit, allowing the vehicle to be safely controlled.

When the amount of precipitation is less than the second reference value w2, on the other hand, the sensors of the sensor group 3 of the vehicle 10 are able to accurately detect the environment surrounding the vehicle 10. The road surface is dry but may also be slightly wet. In some embodiments, when the amount of precipitation around the vehicle 10 is less than the second reference value w2, a lower amount of information than the second reference value r2 is input by the selected control unit, allowing the vehicle to be safely controlled.

When the amount of precipitation is equal to or less than the first reference value w1 and equal to or greater than the second reference value w2, the vehicle 10 has a relatively low amount of rain or snow falling around the vehicle 10. The sensors of the sensor group 3 can detect the environment surrounding the vehicle 10 with relative accuracy. The state of the road surface may be relatively satisfactory.

Therefore when the amount of precipitation is equal to or less than the first reference value w1 and equal to or greater than the second reference value w2, an amount of information that is equal to or less than the first reference value r1 and equal to or greater than the second reference value r2 is input to the selected control unit, so as to moderately ensure safety while reducing power consumption.

FIG. 11B is a diagram illustrating decision on information amount based on terrain information. The terrain information here is the number of lane links around the vehicle 10.

According to this embodiment, when the number of lane links around the vehicle 10 is greater than the first reference value k1, the deciding unit 231 decides on an amount of information greater than a first reference value r1 to be input to the selected control unit. When the number of lane links around the vehicle 10 is less than the second reference value k2, the deciding unit 231 decides on an amount of information less than the second reference value r2 to be input to the selected control unit. When the number of lane links around the vehicle 10 is equal to or less than the first reference value k1 and equal to or greater than the second reference value k2, the deciding unit 231 decides on an information amount that is equal to or less than the first reference value r1 and equal to or greater than the second reference value r2, to be input to the selected control unit.

When the number of lane links around the vehicle 10 is greater than the first reference value k1, power consumption by the selected control unit is highest, when the number of lane links around the vehicle 10 is less than the second reference value k2, power consumption by the selected control unit is lowest, and when the number of lane links around the vehicle 10 is equal to or less than the first reference value k1 and equal to or greater than the second reference value k2, power consumption by the selected control unit is medium.

When the amount of information corresponds to the number of sensors, the first reference value r1 and second reference value r2 correspond to the information amounts of the sensors, the information amount of the sensor for the first reference value r1 being higher than the information amount of the sensor for the second reference value r2.

When the amount of information corresponds to the resolution of the image, the first reference value r1 and second reference value r2 correspond to resolution, the resolution of the first reference value being higher than the resolution of the second reference value r2.

When the amount of information corresponds to the detection frequency of the sensor, the first reference value r1 and second reference value r2 correspond to detection frequency, the detection frequency of the first reference value r1 being higher than the detection frequency of the second reference value r2.

When the number of lane links is greater than the first reference value k1, the vehicle 10 may be traveling on a road with many lanes or near an intersection. Numerous other vehicles or pedestrians may be present around the vehicle 10. Depending on the intersection, the condition of a traffic light signal may be caused to change in a complex manner. The vehicle 10 may also be traveling in the center or commercial area of a large city. In some embodiments, when the number of lane links is greater than the first reference value k1, a greater amount of information than the first reference value r1 is input to the selected control unit, allowing the vehicle to be safely controlled.

When the number of lane links is less than the second reference value k2, on the other hand, the vehicle 10 may be traveling on a road with few lanes or on a road away from intersections. The vehicle 10 may also be traveling on a high-speed road or on a straight road in the suburbs. When the number of lane links is less than the second reference value k2, a lower amount of information than the second reference value r2 may be input to the selected control unit, allowing the vehicle to be safely controlled.

When the number of lane links is equal to or less than the first reference value k1 and equal to or greater than the second reference value k2, the vehicle 10 may be traveling on a road in a residential area or on a city road. Roads in residential areas and city roads are roads whose conditions are also not very complex.

Therefore when the number of lane links is equal to or less than the first reference value k1 and equal to or greater than the second reference value k2, an amount of information that is equal to or less than the first reference value r1 and equal to or greater than the second reference value r2 is input to the selected control unit, so as to moderately ensure safety while reducing power consumption.

In the above explanation, the information amount was decided based on one type of information from among vehicle information, environment information and terrain information, but the information amount may also be decided based on multiple types of information from among vehicle information, environment information and terrain information. For example, a table representing relationships between the speed of the vehicle 10 and number of moving objects, and the amount of information, may be used to decide the information amount based on the speed of the vehicle 10 and the number of moving objects.

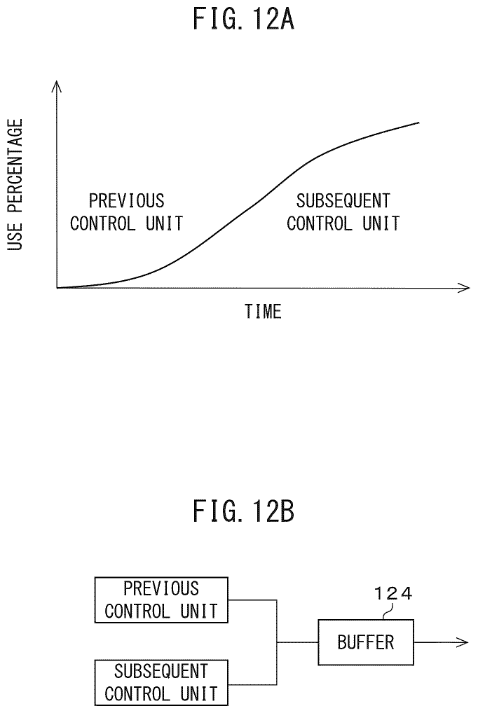

The switching unit 233 of the decision device 13 will now be explained with reference to FIG. 12A and FIG. 12B.

The switching unit 233 inputs the output signal from the control unit before switching and the output signal from the control unit after switching and controls the control device 12 so that the signals output from the control device 12 before and after switching are switched as continuously as possible.

In the example shown in FIG. 12A, the switching unit 233 controls the control device 12 so as to generate a signal that gradually switches from the signal of the control unit before switching to the signal of the control unit after switching. In some embodiments, the control device 12 has a signal control unit 124 that is controlled by the switching unit 233 and generates the signal.

For example, the switching unit 233 gradually changes the ratio between the previous control unit signal and the subsequent control unit signal from 1:0 to 0:1 over a predetermined period of time, from among the output signals from the control device 12.

In the example shown in FIG. 12B, the switching unit 233 controls the control device 12 so that the output signal from the control unit after switching is output as an output signal from the control device 12 only if the output signal from the control unit before switching and the output signal from the control unit after switching are within predetermined reference values. The signal control unit 124 functions as a state prediction buffer.

When operation of the vehicle 10 is relatively stable, the switching unit 233 may switch from the control unit signal before switching to the control unit signal after switching. For example, when the vehicle 10 is stopped, or when the vehicle 10 is traveling at a predetermined speed, the switching unit 233 may switch from the control unit signal before switching to the control unit signal after switching.

The signal control unit 124 of the control device 12 may also apply a lowpass filter or Kalman filter to the output signal from the control unit before switching and the output signal from the control unit after switching, to smooth out rapid fluctuations in the signals.

Since the decision device of the embodiment described above decides on a processing ratio between the portion processed by the first processing unit and the portion processed by the second processing unit, the decision device can control the vehicle in a manner ensuring safety while reducing power consumption, depending on the vehicle conditions.

According to the present disclosure the vehicle control device, computer program for vehicle control and method for controlling a vehicle of the embodiments described above may incorporate appropriate modifications that are still within the gist of the present disclosure. Moreover, the technical scope of the present disclosure is not limited to the embodiments described herein and includes the present disclosure and its equivalents as laid out in the Claims.

For example, the aspect in which the deciding unit decides the processing ratio and the aspect in which the selection unit selects the selection device are not limited to the aforementioned descriptions.

When information has been acquired indicating traffic congestion ahead in the traveling direction of the vehicle, by communication with other vehicles surrounding the vehicle via a communication device, the deciding unit may decide the processing ratio based on that information. In this case the processing ratio may be decided to be 1:0 or 0.5:0.5. This allows the vehicle to be safely controlled with respect to moving objects around the vehicle.

When information has been acquired indicating an accident or obstacle ahead in the traveling direction of the vehicle, by communication with other vehicles surrounding the vehicle or with infrastructure via a communication device, the deciding unit may decide the processing ratio based on that information. In this case the processing ratio may be decided to be 1:0 or 0.5:0.5. This allows the vehicle to be safely controlled in response to the surrounding environment of the vehicle.

In addition, when information has been acquired indicating weather conditions such as rain, fog or snow ahead in the traveling direction of the vehicle, by communication with other vehicles surrounding the vehicle via a communication device, the deciding unit may decide the processing ratio based on that information. In this case the processing ratio may be decided to be 1:0. This allows the vehicle to be safely controlled according to the road surface conditions.

Moreover when information has been acquired indicating road construction or temporary road closure ahead in the traveling direction of the vehicle, by communication with other vehicles surrounding the vehicle via a communication device, the deciding unit may decide the processing ratio based on that information. In this case the processing ratio may be decided to be 1:0 or 0.5:0.5. This allows the vehicle to be safely controlled in response to the surrounding environment of the vehicle.

Moreover when information has been acquired indicating a vehicle being driven abnormally ahead in the traveling direction of the vehicle, by communication with other vehicles surrounding the vehicle via a communication device, the deciding unit may decide the processing ratio based on that information. In this case the processing ratio may be decided to be 1:0 or 0.5:0.5. This allows the vehicle to be safely controlled in rapid response to the surrounding environment of the vehicle.

1. A vehicle control device comprising:
a first processing device that generates an output signal using only a machine learning-trained classifier;
a second processing device that has lower power consumption than the first processing device and generates an output signal without using a machine learning-trained classifier; and
a processor configured to decide a processing ratio between a portion processed by the first processing device and a portion processed by the second processing device, based on at least one information from among vehicle information representing a state of a vehicle, environment information representing surrounding environment of the vehicle, and terrain information representing terrain including a current location of the vehicle.

2. The vehicle control device according to claim 1, further comprising:
a plurality of the first processing devices;
a plurality of the second processing devices;
a first control device that has one of the first processing devices and one of the second processing devices;
a second control device that has higher power consumption than the first control device and generates an output signal using only another of the first processing devices; and
a third control device that has lower power consumption than the first control device and generates an output signal using only another of the second processing devices,
and wherein the processor is further configured to select a selected control device for control of the vehicle from among the first control device, second control device and third control device based on the decided processing ratio.

3. The vehicle control device according to claim 1, wherein
the vehicle information includes degree of operation of the vehicle, and
the processor is further configured to decide the processing ratio according to the degree of operation of the vehicle.

4. The vehicle control device according to claim 3, wherein
the vehicle information includes speed of the vehicle, and
the processor is further configured to decide the processing ratio so that the portion processed by the first processing device is greater than the portion processed by the second processing device when the speed of the vehicle is slow compared to when the speed of the vehicle is fast.

5. The vehicle control device according to claim 1, wherein
the environment information includes complexity of the surrounding environment of the vehicle, and
the processor is further configured to decide the processing ratio so that the portion processed by the first processing device is greater than the portion processed by the second processing device when the degree of complexity of the surrounding environment of the vehicle is high, compared to when the degree of complexity of the surrounding environment of the vehicle is low.

6. The vehicle control device according to claim 1, wherein
the terrain information includes degree of complexity of the terrain including the current location of the vehicle, and
the processor is further configured to decide the processing ratio so that the portion processed by the first processing device is greater than the portion processed by the second processing device when the degree of complexity of the terrain including the current location of the vehicle is high, compared to when the degree of complexity of the terrain including the current location of the vehicle is low.

7. The vehicle control device according to claim 2, wherein the processor is further configured to decide amount of information to be input to the selected control device that has been selected, based on at least one information from among the vehicle information, environment information and terrain information.

8. The vehicle control device according to claim 7, wherein the amount of information includes number of sensors with which detected information is input to the selected control device, the resolution of image input to the selected control device, and detection frequency of a sensor with which detected information is input to the selected control device.

9. A computer-readable, non-transitory storage medium storing a computer program for vehicle control, which causes a processor to execute a process, and the process comprising:
deciding a processing ratio between a portion processed by a first processing device that generates an output signal using only a machine learning-trained classifier, and a portion processed by a second processing device that has lower power consumption than the first processing device and generates an output signal without using a machine learning-trained classifier, based on at least one information from among vehicle information representing a state of a vehicle, environment information representing surrounding environment of the vehicle, and terrain information representing a terrain including a current location of the vehicle.

10. A method for controlling a vehicle carried out by a vehicle control device and the method comprising:
deciding a processing ratio between a portion processed by a first processing device that generates an output signal using only a machine learning-trained classifier, and a portion processed by a second processing device that has lower power consumption than the first processing device and generates an output signal without using a machine learning-trained classifier, based on at least one information from among vehicle information representing a state of a vehicle, environment information representing surrounding environment of the vehicle, and terrain information representing a terrain including a current location of the vehicle.
